(19) United States
(12) Patent Application Publication
(10) Pub. No.: US 2024/0333046 A1
(43) Pub. Date: Oct. 3, 2024

(54) SUSTAINABLE WOUND ROTOR MOTOR

(71) Applicant: BorgWarner Inc., Auburn Hills, MI (US)

(72) Inventors: David A. Fulton, Anderson, IN (US); Kirk Neet, Noblesville, IN (US)

(21) Appl. No.: 18/618,375

(22) Filed: Mar. 27, 2024

Related U.S. Application Data
(60) Provisional application No. 63/455,513, filed on Mar. 29, 2023.

(51) Int. Cl. H02K 1/02; H02K 3/34; H02K 3/52; H02K 15/00

(52) U.S. Cl. CPC H02K 1/02; H02K 3/34; H02K 3/527; H02K 15/00

(57) ABSTRACT

An electric machine including a rotor comprising metal and plastic portions, the plastic portions being exclusively of thermoplastic material. An electric machine including a rotor, the rotor including a shaft, a coil disposed adjacent the shaft, a first thermoplastic material disposed on the rotor and having a first melting point, a second thermoplastic material disposed on the rotor and having a second melting point at least 20 degrees C. higher than the first melting point. A method for making a recyclable electric machine including assembling a rotor consisting of a plurality of metallic components, and a plurality of plastic portions, the plastic portions consisting of thermoplastic material.

### CROSS REFERENCE TO RELATED APPLICATIONS

This application claims the benefit of an earlier filing date from U.S. Provisional Application Ser. No. 63/455,513 filed Mar. 29, 2023, the entire disclosure of which is incorporated herein by reference.

### BACKGROUND

Electric machines have been employed in motor vehicles for many decades to generate electric power through mechanical input from the internal combustion engine of the vehicle. While such electric machines have a long working life, they do eventually break down and require replacement. The materials contained within faulty electric machines are valuable and can be recycled but unfortunately the processes to segregate the valuable materials can be costly. It would be beneficial to the industry if the cost and complexity of recycling electric machines could be reduced.

### SUMMARY

An embodiment of an electric machine including a rotor comprising metal and plastic portions, the plastic portions being exclusively of thermoplastic material.

An embodiment of an electric machine including a rotor, the rotor including a shaft, a coil disposed adjacent the shaft, a first thermoplastic material disposed on the rotor and having a first melting point, a second thermoplastic material disposed on the rotor and having a second melting point at least 20 degrees C. higher than the first melting point.

An embodiment of a method for making a recyclable electric machine including assembling a rotor consisting of a plurality of metallic components, and a plurality of plastic portions, the plastic portions consisting of thermoplastic material.

### BRIEF DESCRIPTION OF THE DRAWINGS

The following descriptions should not be considered limiting in any way. With reference to the accompanying drawings, like elements are numbered alike:

FIG. 1 is a perspective view of a rotor for an electric machine as disclosed herein;

FIG. 2 is a perspective view of an end cap of the rotor of FIG. 1;

FIG. 3 is another perspective view of the rotor of FIG. 1 from a different angle and enlarged;

FIG. 4 is a perspective view of the rotor of FIG. 1 but with end covers installed thereon and ready for insertion in a stator; and

FIG. 5 is a perspective view of a stator as disclosed herein that may be employed with the rotor of FIG. 1 or with other rotors.

### DETAILED DESCRIPTION

A detailed description of one or more embodiments of the disclosed apparatus and method are presented herein by way of exemplification and not limitation with reference to the Figures.

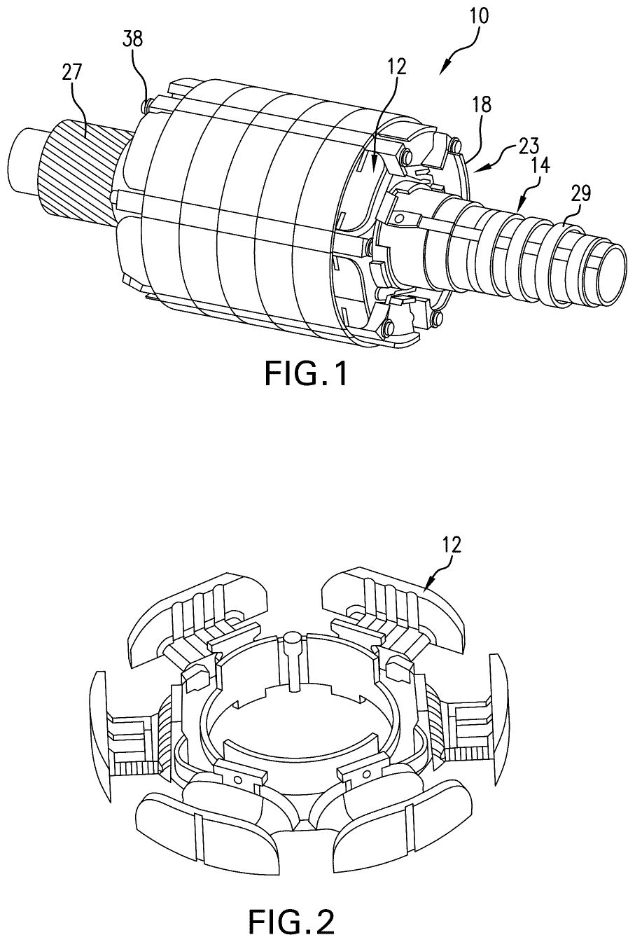

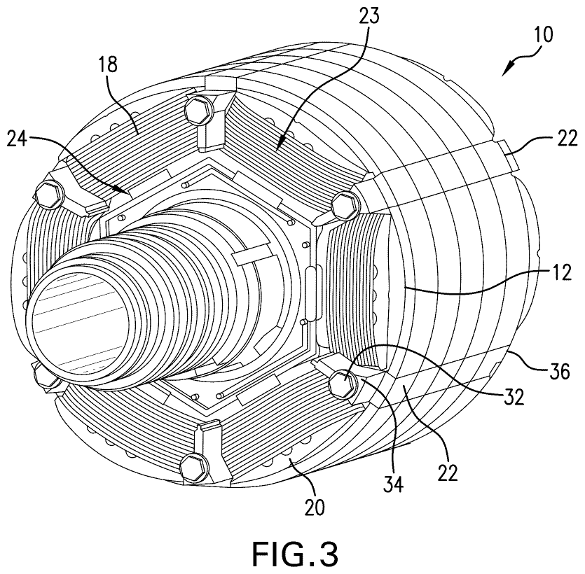

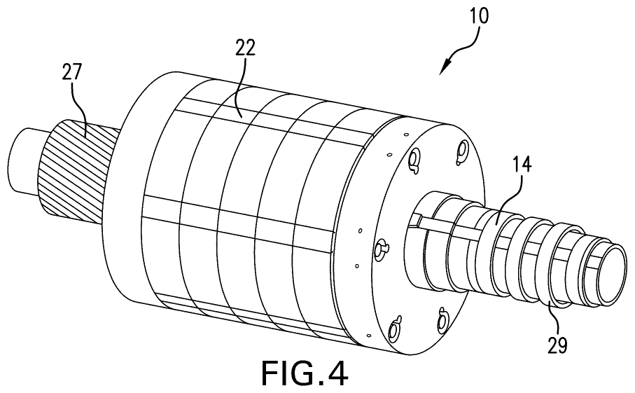

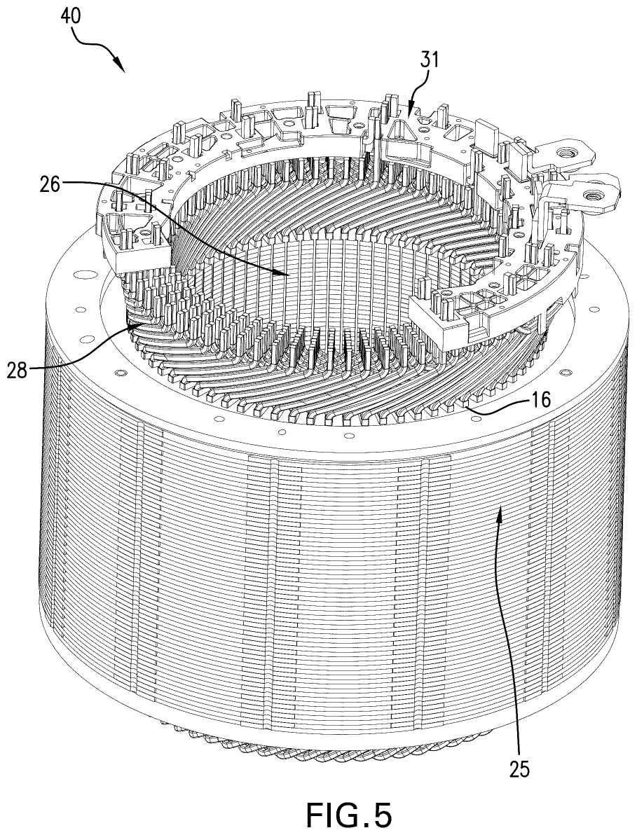

Referring to FIGS. 1-5, a rotor 10 and a stator 40 are major components of an electric machine. In accordance with teaching hereof, use of either the rotor 10 or the stator 40 or both in a particular electric machine will dramatically reduce the cost and complexity of recovering materials after removing the electric machine from service. The rotor 10 and/or stator 40 include metal components and plastic components, wherein the plastic components or portions of components are exclusively formed of a thermoplastic material. In embodiments, only one single thermoplastic material is used while in other embodiment more than one thermoplastic material may be used under conditions discussed below. In all cases, thermoset materials are entirely excluded. The components or portions that may be plastic materials include, for example, end caps 12, plastic parts of slip rings 14, slot liners 16, insulation on wire 18, covering on wire 20, spacers 22 between coils 23, busbars 24, wedges 26, insulation 28 on hairpin welds, etc., all exclusively made with a single thermoplastic material. In the art, many different materials were used for these components, including varnish, thermoset materials, epoxy, etc. The materials have traditionally been selected to optimize functionality without regard for recycling of faulty or retired electric machines. In accordance with the teaching hereof, each of the listed components is composed of the same thermoplastic material for a particular rotor (FIG. 1), stator (FIG. 5), or stator and rotor combination. Ensuring that only thermoplastic materials that have disparate melting or liquification temperatures, used in a rotor, stator or combination of rotor and stator in addition to the metallic parts such as the actual wire of the coil 23, the laminations 25 shaft 27, metal slip rings 29, copper tracks 31 in a plastic housing, magnets 33, etc. ensures elimination of the task of separating distinct plastic materials during the recycling operation. The use of different melting temperatures with for example a 20 degrees Celsius differential, ensures that only one of the thermoplastic materials will be removed in the recycling operation at a first temperature; and only one other will be removed at a second temperature, and so on.

Materials contemplated for use in the rotor 10 or stator 40 include Polyether Ether Ketone (PEEK), Polyphenylene Sulfide (PPS), silicone, acrylic, Polyamide, Glass filled Polyamide, Polyimide, Polyester (Polyethylene Terephthalate or PET), Perfluoroalkoxy (PFA). Any of these thermoplastic materials are acceptable. With a or a number of different thermoplastic materials having a different enough melting temperature, each thermoplastic material can be liquified at a specific temperature. For example. PEEK melts at 350 degrees C. to 380 degree C., whereas PPS melts at 280 degrees C. to 300 degrees C. and therefore makes a good pairing should two different thermoplastic materials be used in the same rotor. The temperatures may be relatively high to ensure the rotor, and potential stator that may be constructed in the same way, will operate in the relatively high temperatures that are common in motor vehicle engine bays, such as about 200 degrees Celsius. Melting temperatures of the thermoplastic materials of at least 20 degrees C. higher than the operating conditions are contemplated so that the materials will be stable at the operating condition temperature but will liquify or reflow (used interchangeably herein since the goal is to make the material mobile) at for example 20 degrees C. above the operating temperature. Therefore, mounting a rotor in a recycling machine that is capable of spinning the rotor at speeds in a range of about 1000 to about 5000 revolutions per minute (RPM) and raising the temperature of the rotor or stator to above the liquification or reflow temperature of the selected thermoplastic material will result in all of that particular thermoplastic plastic material of the rotor moving radially outwardly to be collected in a collection area, and leaving the metal components of the rotor 10 such as coils 23, shaft 27, slips rings 29, etc. to be collected and also recycled. In the event a second thermoplastic material having a higher melt temperature is also employed, that material would remain with the metal components until the rotor temperature was raised further in the same or a different recycling device. Likewise, the plastic material of the stator 40 can be collected in the same way. Again, in embodiments, the difference in the liquification temperature will be at least 20 degrees C. Where such an embodiment is used, recycling of independent thermoplastic materials may be achieved by first heating the rotor or stator to the first liquefication temperature to remove the thermoplastic material that liquifies at that temperature, removing that recovered plastic and heating to a second or subsequent higher temperature to remove the next plastic material. The removal may be in the same removal device with material collection in between or the rotor can be moved to different devices to experience the different temperatures so like thermoplastic material is only collected in one device while other like thermoplastic material is collected in another device. Because all of the plastic material is of the same type, the recovered material need not be further segregated but rather is ready for recycling. The goal of the recycler machines is to separate the plastics from the metal and separate the different plastics from each other. Therefore, the desire is to only extract one thermoplastic at the first recycling temperature, and only one thermoplastic material at the second higher recycling temperature. Consequently, in an example, the electric machine should be comprised of only one thermoplastic material which reflows at the lower recycling temperature and only one thermoplastic material that reflows at the higher recycling temperature. Also, the stator and rotor can easily be separated by removing the rotor from inside the stator. Therefore, the rotor and stator can be recycled as one unit or they could be separated and recycled separately as two units. For the first recycle option, the stator and rotor should be comprised of the same first thermoplastic material and the same second thermoplastic material. For the second recycle option, the rotor and stator could be comprised of different thermoplastic materials.

Those of skill in the art will recognize the value of Varnish in that it is applied in a liquid to seep around a coil thereby tending to hold the coils in place and together. Varnish is however, a thermoset material and hence difficult to recycle. In accordance with the disclosure hereof, Varnish is to be avoided. Electric machines devoid of varnish are more easily recyclable. With a thermoplastic material, it may be more difficult to achieve the low initial viscosity of varnish and hence may be somewhat more difficult to achieve the fixation for the coils that has previously been provided by varnish. In these cases, the spacers 22 (of the one of the same thermoplastic materials) so that they are recyclable in the same liquification and spinning operation. The spacers 22 may be configured with through holes 30 that accept fasteners such as bolts 32 that extend from a first end 34 of the coils 23 to a second end 36 of the coils 23. A nut 38 (FIG. 1) may be tightened on the bolt 32 that causes the spacer 22 to expand circumferentially and radially, the spacer having a Poisson's ratio in a range of about 0.1 to about 0.5. The circumferential expansion of the spacer 22 fixes the coils 23 in place. The spacers 22 have a sufficiently large Poisson's ratio that the coils 23 are reliably fixed in place and such that varnish is completely unnecessary in the rotor 10 (or in a stator 40 using a similar spacer 22). Another way to avoid the varnish is to wrap the entire coil 23 with a cover 20 such as a heat shrink tubing that is formed from a thermoplastic material such as polyolefin, polytetrafluoroethylene (PTFE), copolymer of hexafluoropropylene and vinylidene difluoride (FKM), etc. The heat shrink tubing is placed around the outer surface of each coil covering the two sides and the two ends of each coil. The heat shrink tubing is then heated to shrink and create some compression on the coil thereby holding the coil together and in place. Similarly, a thermoplastic tape could be used to wrap around the outer surface of each coil, covering the two sides and the two ends of each coil. The tape could be formed of polyester, polyamide, polyimide are any other similar type of thermoplastic.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An electric machine comprising:
a rotor comprising metal and plastic portions, the plastic portions being exclusively of thermoplastic material.

2. The electric machine as claimed in claim 1, wherein the rotor further includes a coil, the coil being devoid of varnish.

3. The electric machine as claimed in claim 1, including a spacer disposed between the coil and an adjacent coil and configured to accept a fastener therethrough and which spacer exhibits a Poisson's ratio.

4. The electric machine as claimed in claim 3, wherein the Poisson's ratio is in a range of ratios from about 0.1 to about 0.5.

5. The electric machine as claimed in claim 1, wherein the plastic portions are exclusively of a single thermoplastic material.

6. The electric machine as claimed in claim 2, wherein a thermoplastic tape is wound around an outside surface of the coil.

7. The electric machine as claimed in claim 2, wherein a thermoplastic shrink tube is disposed about the coil.

8. The electric machine as claimed in claim 1, further including a stator, the stator comprising metal and plastic portions, the plastic portions being exclusively of thermoplastic material.

9. The electric machine of claim 8, wherein the stator further includes a coil, the coil being devoid of varnish.

10. The electric machine as claimed in claim 8, wherein the stator and rotor plastic portions are exclusively of a single thermoplastic material.

11. The electric machine as claimed in claim 8, wherein the plastic portions include end caps, plastic part of slip rings, slot liners, insulation on wire, covering on coils, spacers between coils, busbars, wedges, and insulation covering on hairpin welds.

12. An electric machine comprising:
a rotor, the rotor comprising;
a shaft;
a coil disposed adjacent the shaft;
a first thermoplastic material disposed on the rotor and having a first melting point;
a second thermoplastic material disposed on the rotor and having a second melting point at least 20 degrees C. higher than the first melting point.

13. The electric machine as claimed in claim 12, wherein the rotor comprises only one first thermoplastic material and only one second thermoplastic material.

14. The electric machine of claim 12, wherein the coil is devoid of varnish.

15. The electric machine of claim 12, further including a stator, the stator comprising only one of the first thermoplastic material and only one of the second thermoplastic material.

16. The electric machine of claim 15, wherein the first thermoplastic material of the stator is the same material as the first thermoplastic material of the rotor.

17. The electric machine of claim 16, wherein the second thermoplastic material of the stator is the same material as the second thermoplastic material of the rotor.

18. A method for making a recyclable electric machine comprising:
assembling a rotor consisting of a plurality of metallic components, and a plurality of plastic portions, the plastic portions consisting of thermoplastic material.

19. The method as claimed in claim 18, further including assembling a stator:
consisting of a plurality of metallic components, and a plurality of plastic portions, the plastic portions consisting of thermoplastic material.

20. The method as claimed in claim 19, wherein the plastic portions are exclusively of a single thermoplastic material.
